(19) United States
(12) Patent Application Publication
(10) Pub. No.: US 2009/0006804 A1
(43) Pub. Date: Jan. 1, 2009

(54) BI-LEVEL MAP STRUCTURE FOR SPARSE ALLOCATION OF VIRTUAL STORAGE

(75) Inventors: CLARK EDWARD LUBBERS, COLORADO SPRINGS, CO (US); RANDY L. ROBERSON, SPRING HILL, FL (US)

Correspondence Address: McCarthy Law Group, 5830 Northwest Expressway, #353, Oklahoma City, OK, 73132, US

(73) Assignee: Seagate Technology LLC, Scotts Valley, CA (US)

(21) Appl. No.: 11/771,685

(22) Filed: Jun. 29, 2007

(51) Int. Cl. G06F 12/02

(52) U.S. Cl. 711/203; 711/E12.002

(57) ABSTRACT

Apparatus and method for accessing a virtual storage space. The space is arranged across a plurality of storage elements, and a skip list is used to map as individual nodes each of a plurality of non-overlapping ranges of virtual block addresses of the virtual storage space from a selected storage element.

### BACKGROUND

Data storage devices are used in a variety of applications to store and retrieve user data. The data are often stored to internal storage media, such as one or more rotatable discs accessed by an array of data transducers that are moved to different radii of the media to carry out I/O operations with tracks defined thereon.

Storage devices can be grouped into storage arrays to provide consolidated physical memory storage spaces to support redundancy, scalability and enhanced data throughput rates. Such arrays are often accessed by controllers, which in turn can communicate with host devices over a fabric such as a local area network (LAN), the Internet, etc. A virtual storage space can be formed from a number of devices to present a single virtual logical unit number (LUN) to the network.

### SUMMARY

Various embodiments of the present invention are generally directed to an apparatus and method for accessing a virtual storage space.

In accordance with preferred embodiments, the virtual storage space is arranged across a plurality of storage elements, and a skip list is used to map as individual nodes each of a plurality of non-overlapping ranges of virtual block addresses of the virtual storage space from a selected storage element.

### BRIEF DESCRIPTION OF THE DRAWINGS

FIG. 1 shows an exemplary data storage device.

FIG. 2 depicts a network system that incorporates the device of FIG. 1.

FIG. 3 generally shows respective top level map (TLM) and bottom level map (BLM) structures utilized in conjunction with a virtual space of FIG. 2.

FIG. 4 generally illustrates a preferred arrangement of the BLM of FIG. 3 as a skip list.

FIG. 5 correspondingly shows non-adjacent VBA ranges on a selected ISE of FIG. 2.

### DETAILED DESCRIPTION

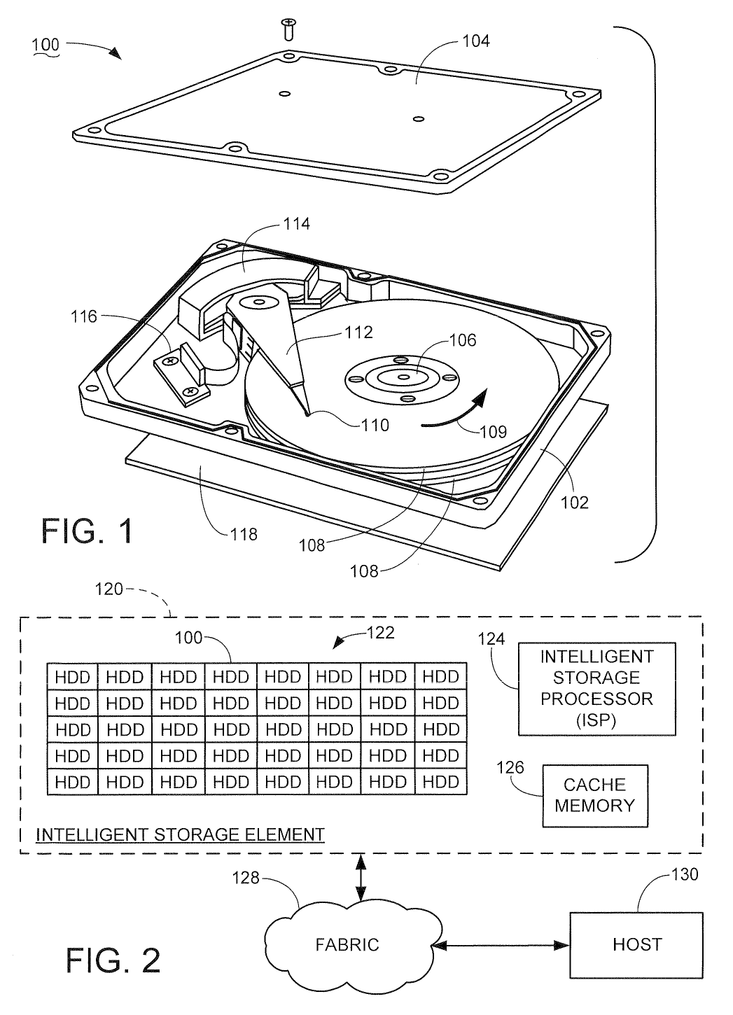

FIG. 1 shows an exemplary data storage device in accordance with various embodiments of the present invention. The device is characterized as a hard disc drive of the type configured to store and transfer user data with a host device, although such is not limiting.

The device 100 includes a housing formed from a base deck 102 and top cover 104. A spindle motor 106 rotates a number of storage media 108 in rotational direction 109. The media 108 are accessed by a corresponding array of data transducers (heads) 110 disposed adjacent the media to form a head-disc interface (HDI).

A head-stack assembly (“HSA” or “actuator”) is shown at 112. The actuator 112 rotates through application of current to a voice coil motor (VCM) 114. The VCM 114 aligns the transducers 110 with tracks (not shown) defined on the media surfaces to store data thereto or retrieve data therefrom. A flex circuit assembly 116 provides electrical communication paths between the actuator 112 and device control electronics on an externally disposed printed circuit board (PCB) 118.

In some embodiments, the device 100 is incorporated into a multi-device intelligent storage element (ISE) 120, as shown in FIG. 2. The ISE 120 comprises a plurality of such devices 100, such as 40 devices, arranged into a data storage array 122. The ISE 120 further comprises at least one programmable intelligent storage processor (ISP) 124, and associated cache memory 126. The array 122 forms a large combined memory space across which data are striped, such as in a selected RAID (redundant array of independent disks) configuration. The ISP 124 operates as an array controller to direct the transfer of data to and from the array.

The ISE 120 communicates across a computer network, or fabric 128 to any number of host devices, such as exemplary host device 130. The fabric can take any suitable form, including the Internet, a local area network (LAN), etc. The host device 130 can be an individual personal computer (PC), a remote file server, etc. One or more ISEs 120 can be combined to form a virtual storage space, as desired.

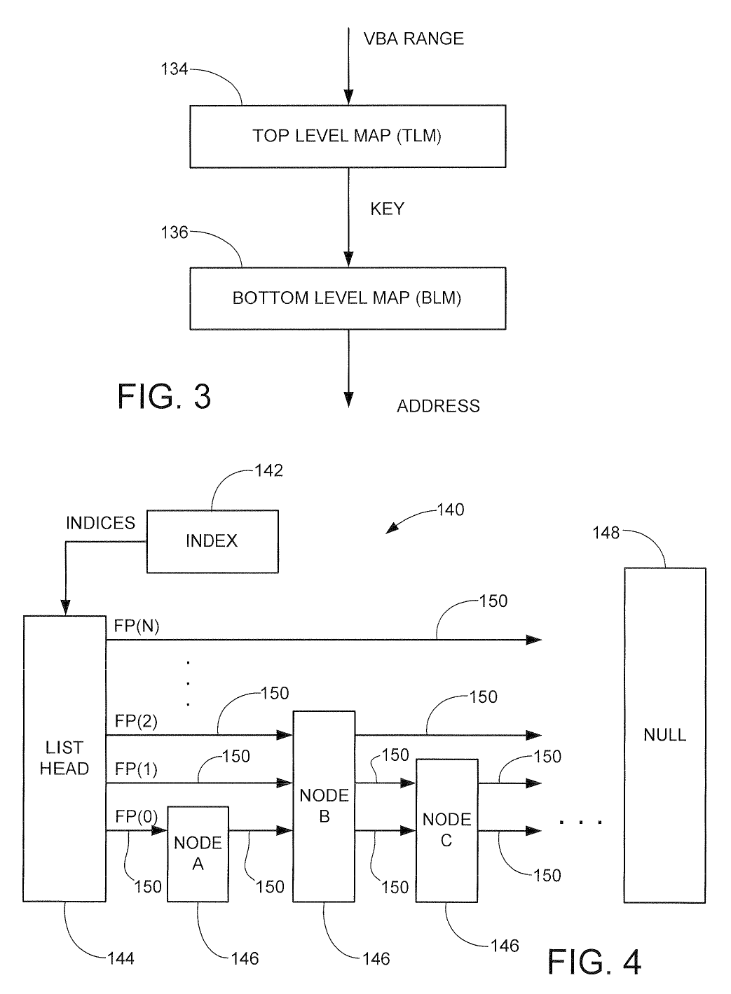

A novel map structure is used to facilitate accesses to the virtual storage space. As shown in FIG. 3, these structures preferably include a top level map (TLM) 134 and a bottom level map (BLM) 136. Preferably, a selected VBA address, or range of addresses, associated with a particular I/O request are initially provided to the TLM to locate the BLM entries associated with that range. The BLM in turn operates to identify physical addresses to enable the request to be directed to the appropriate location(s) within the space. Multiple TLM entries can point to the same BLM entry.

The TLM 134 is preferably arranged as a flat table (array) of BLM indices, each of which points to a particular BLM entry. As will be recognized, every address in a flat table has a direct lookup. BLM entries in turn are allocated using a lowest available scheme from a single pool serving all virtual storage for a storage element. The size of a TLM entry is selected to match the size of a BLM entry, which further enhances flexibility in both look up and allocation. This structure is particularly useful in sparse allocation situations where the actual amount of stored data is relatively low compared to the amount of available storage.

In accordance with various embodiments, the BLM entries are each preferably characterized as an independent skip list, as set forth by FIG. 4. As will be recognized, a skip list is a form of a linked list where each item, or node, in the list has a random number of extra forward pointers. Searching such a list approximates the performance of searching binary trees, while having dramatically lower cost in terms of maintenance as compared to a binary tree.

Generally, a skip list is maintained in an order based on comparisons of a key field within each node. The comparison is arbitrarily selected and may be ascending or descending, numeric or alpha-numeric, and so forth. When a new node is to be inserted into the list, a mechanism is generally used to assign the number of forward pointers to the node in a substantially random fashion. The number of extra forward pointers associated with each node is referred to as the node level.

A generalized architecture for a skip list is set forth at 140 in FIG. 4, and is shown to include an index input 142, a list head 144, a population of nodes 146 (the first three of which are denoted generally as A, B, C), and a null pointer block 148. Forward pointers (FP) from 0 to N are generally represented by lines 150. The index 142 is supplied from the TLM 134, as noted above.

Each node 146 is preferably associated with a non-overlapping range of VBA addresses within the virtual space, which serves as the key for that node. The number of forward pointers 150 associated with each node 146 is assigned in a substantially random fashion upon insertion into the list 140. The number of extra forward pointers for each node is referred to as the node level for that node.

Preferably, the number of forward pointers 150 is selected in relation to the size of the list. Table 1 shows a representative distribution of nodes at each of a number of various node levels where 1 of N nodes have a level greater than or equal to x.

TABLE 1

| Level | 1 Out Of “N” | LZ |
|---|---|---|
| 1 | 4 | 2 |
| 2 | 16 | 4 |
| 3 | 64 | 6 |
| 4 | 256 | 8 |
| 5 | 1024 | 10 |
| 6 | 4,096 | 12 |
| 7 | 16,384 | 14 |
| 8 | 65,536 | 16 |
| 9 | 262,144 | 18 |
| 10 | 1,048,576 | 20 |
| 11 | 4,194,304 | 22 |
| 12 | 16,777,216 | 24 |
| 13 | 67,108,864 | 26 |
| 14 | 268,435,456 | 28 |
| 15 | 1,073,741,824 | 30 |

The values in the LZ (leading zeroes) column generally correspond to the number of index value bits that can address each of the nodes at the associated level (e.g., 2 bits can address the 4 nodes in Level 1, 4 bits can address the 16 nodes in Level 2, and so on). It can be seen that Table 1 provides a maximum pool of 1,073,741,824 (0x40000000) potential nodes using a 30-bit index.

From Table 1 it can be seen that, generally, 1 out of 4 nodes will have a level greater than “0”; that is, 25% of the total population of nodes will have one or more extra forward pointers. Conversely, 3 out of 4 nodes (75%) will generally have a level of “0” (no extra forward pointers). Similarly, 3 out of 16 nodes will generally have a level of “1”, 3 out 64 nodes will have a level of “2”, and so on.

If the list is very large and the maximum number of pointers is bounded, searching the list will generally require an average of about n/2 comparisons at the maximum level, where n is the number of nodes at that level. For example, if the number of nodes is limited to 16,384 and the maximum level is 5, then on average there will be 16 nodes at level 5 (1 out of 1024). Every search will thus generally require, on average, 8 comparisons before dropping to comparisons at level 4, with an average of 2 comparisons at levels 4 through 0.

Searching the skip list 140 generally involves using the list head 144, which identifies the forward pointers 150 up to the maximum level supported. A special value can be used as the null pointer 148, which is interpreted as pointing beyond the end of the list. Deriving the level from index means that a null pointer value of “0” will cause the list to be slightly imbalanced. This is because an index of “0” would otherwise reference a particular node at the maximum level.

It is contemplated that the total number of nodes will be preferably selected to be less than half of the largest power of 2 that can be expressed by the number of bits in the index field. This advantageously allows the null pointer to be expressed by any value with the highest bit set. For example, using 16 bits to store the index and a maximum of 32,768 nodes (index range is 0x0000-0x7FFF), then any value between 0x8000 and 0xFFFF can be used as the null pointer.

In accordance with preferred embodiments, each independent skip list in the BLM 136 (referred to herein as a segmented BLM, or SBLM 140) maps up to a fixed number of low level entries from the spaces addressed from multiple entries in the TLM 134. The nodes 146 are non-overlapping ranges of VBA values within the virtual space 132 associated with a selected ISE 120.

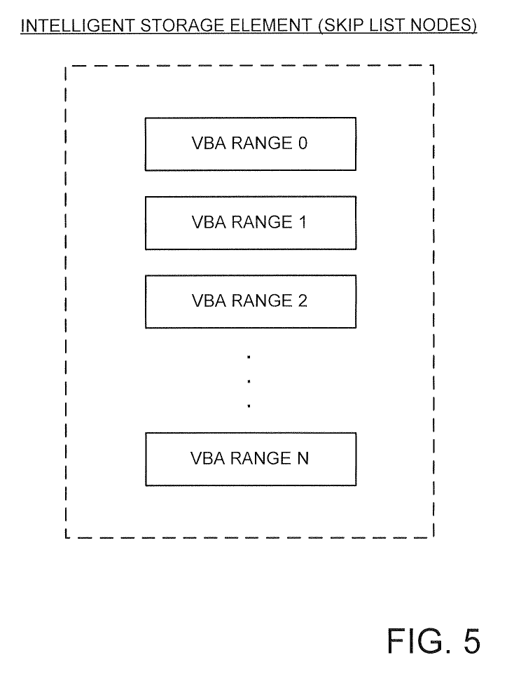

More particularly, as shown in FIG. 5, each of the nodes 146 of a particular SBLM 140 will map as individual nodes each of a plurality of non-overlapping ranges of virtual block addresses, such as the VBA Ranges 0-N in FIG. 5. These ranges are preferably taken from a virtual storage space of a selected storage element, such as the ISE 120 in FIG. 2.

Any number of TLM entries within a quadrant (one-quarter) of the TLM 134 can point to a given BLM skip list since the ranges in that quadrant will be non-overlapping. Byte indices are used as the key values used to access the skip list, and the actual VBA ranges of each node 146 can be sized and adjusted as desired.

Each SBLM 140 is preferably organized as six tables and three additional fields. The first three tables store link entries. One table holds an array of “Even Long Link Entry” (ELLE) structures. Another table holds an array of “Odd Long Link Entry” (OLLE) structures. The third table holds an array of “Short Link Entry” (SLE) structures. A “Long Link Entry” (LLE) consists of 4 1-byte link values. A “Short Link Entry” (SLE) consists of 2 1-byte link values.

The next two tables in the SBLM hold data descriptor data. One stores 4-byte entries for row address values, referred to herein as reliable storage unit descriptors (RSUDs). The RSUD can take any suitable format and preferably provides information with regard to book ID, row ID, RAID level, etc. for the associated segment of data (Reliable Storage Unit) within the ISE 120 (FIG. 2). For reference, an exemplary 32-bit RSUD format is set forth by Table 2:

TABLE 2

| No. of Bits | Description | Comments |
|---|---|---|
| 3 | Device Organization | Up to eight (8) different device |
| | | organizations |
| 7 | Book ID | Up to 128 books |
| 1 | D-Bit | 1 => DIF invalid flag |
| 3 | RAID Level | Up to 8 RAID organizations |
| 18 | Row ID | Covers 0.25 TB at 8 MB grains |

The exemplary RSUD of Table 2 is based on dividing devices 100 in the ISE array (FIG. 2) into segments of ⅛th capacity and forming books from these segments. With 128 devices 100 in the associated array, a maximum of 128 books could be used with 0% sparing. Consequently, the Book ID value is 7 bits (2⁷=128). Assuming each device 100 has a capacity of 2 TB (terabytes, or 10¹² bytes), and an RSU size of 8 MB, 18 bits are required to specify the associated row number for that RSU.

Continuing with the exemplary SBLM structure, the next table therein provides 2-byte entries to hold so-called Z-Bit values used to provide status information, such as snapshot status for the data (Z refers to “Zeroing is Required). The last table is referred to as a “Key Table” (KT), which holds 2-byte VBA Index values. The VBA Index holds 16 bits of the overall VBA. The low-order 14 bits are not relevant since the VBA Index references an 8 MB virtual space (16K sectors). The upper two bits of the VBA are derived from the quadrant referenced in the TLM. Thus, an SBLM generally will not be shared between entries in different quadrants of the TLM.

The VBA Index is the “key” in terms of searching the skip list implemented in the SBLM 140. As noted above, each SBLM implements a balanced skip list with address-derived levels and 1-byte relative index pointers. The skip list supports four levels and a maximum of 201 entries. Using an address related table structure (ARTS), the key is located in the Key Table by using the pointer value as an index. The RSUD Table and the Z Bit Table are likewise referenced once an entry is found based on the key.

The foregoing SBLM 140 structure is exemplified in Table 3. This structure will accommodate a total of 201 entries (nodes).

TABLE 3

| | |
|---|---|
| 0x0000 | Skip List Head |
| 0x0004 | Even Long Link Entries (4, 6, 8, 10, 12, 14) |
| 0x0020 | Short Link Entries (16 . . . 201) |
| 0x0194 | Free List Head |
| 0x0196 | Allocated Entry Count |
| 0x0198 | Key Table Entries (1 . . . 201) - Base: 0x0196 |
| 0x032A | Z Bit Table Entries (1 . . . 201) - Base: 0x0328 |
| 0x04BC | RSUD Table Entries (1 . . . 201) - Base: 0x04B8 |
| 0x07E0 | Odd Long Link Entries (1, 3, 5, 7, 9, 11, 13, 15) - |
| | Base: 0x07DC |

The SBLM will be initialized from a template where the “free list” contains all the ELLE, OLLE, and SLE structures, linked in an order equivalent to a “pseudo-random” distribution of the entries such that nodes are picked with a random level from 0 to 3. The level of a node is derived from the index by determining the first bit set using an FFS instruction. This will produce a value between 1 and 7 since the index varies between 0x01 and 0xC9. This number is shifted right 1 to produce a value between 0 and 3, which is subtracted from 3 to produce the level.

All tables are accessed by multiplying the entry index by the size of an entry and adding the base. For linking purposes only, a special check may be made to see if the level is greater than 1 and the index is odd. If so, the OLLE table base is used instead of the ELLE table base. The list produced by these factors will be nominally balanced, although there may be fewer level 0 entries than might be expected (137 instead of 192) since entries with indices between 202 and 255 inclusive will not exist (since the SBLM 140 of Table 2 is preferably limited to 201 total nodes).

The SBLM 140 is referenced from the TLM 134. Generally, any number of SBLM entries may be referenced from any number of entries in the same quadrant of the TLM 134. This is because there will be no overlap in the key space for entries from the same quadrant. When a given key is not found in an SBLM pointed to by the appropriate entry in the TLM, which is still flat in terms of VBA access, an entry is inserted in that SBLM if one is available. If none is available, the SBLM is split by moving as close to half of the entries as possible based on finding the best dividing line in terms of a 2 GB boundary. In this way, the total number of SBLMs 140 within the BLM 136 will adjust in relation to the utilization level of the virtual space.

If no division is possible because the particular SBLM 140 is only serving a single entry, the SBLM is preferably converted to a “flat” BLM; that is, an address array that provides direct lookup for the RSUD values. A flat BLM will take up the same memory as an SBLM, but will accommodate up to 256 entries. The SBLM of Table 2 thus is about ⅘ as efficient as a flat BLM (201/256=78.516%).

At this point it may be helpful to briefly discuss the usefulness of an SBLM as compared to a flat BLM structure. Those skilled in the art may have initially noted that, for the same amount of memory space, the SBLM holds fewer entries as compared to a flat BLM, and requires additional processing resources to process a skip list search.

Nevertheless, SBLMs can be preferable from a memory management standpoint. For example, in a sparse allocation case, entries that may have required several flat BLMs to map can be accumulated into a single SBLM structure, and searched in a relatively efficient manner from a single list.

Subsequent conversion to a flat BLM preferably comprises replacing the SBLM with a simple table structure with VBA address indices (for direct lookup from the TLM entries) and associated RSUDs as the lookup data values.

When a null entry is encountered in the TLM, some number of occupied entries in the vicinity (including the same quadrant) should be considered. The percentage free should be calculated. If the nearest SBLM is less than perhaps 50% full, it should be used. Otherwise, some algorithm to select the one based on some combination of free capacity and “nearness” should be invoked to choose an SBLM to use. If none can be found, a new SBLM should be allocated and initialized by copying in the SBLM template.

In the proposed SBLM data structure, so-called R-Bits, which identify a snapshot LUN (R refers to “Reference in Parent”) would be accessed using the index of the entry with the appropriate key. The R-Bits can present an issue if the grain size for copying (e.g. 128 KB) which does not match the Z-bit granularity (e.g., 512 KB). On the other hand, if the Z-Bit and R-Bit granularities are the same, more data may need to be copied, but the separate use of R-Bits could be eliminated and just one C-Bit (Condition Bit) could be used. For an original LUN, the C-Bit would indicate whether or not the data were ever written. For a snapshot LUN, the C-Bit would indicate whether or not the LUN actually holds the data. When it is necessary to copy from unwritten data, no data should be copied and the C-Bit should be cleared. Thus, a disadvantage to the use of a single C-Bit is that it generally cannot be determined that a particular set of data are unwritten data after unwritten data are copied in a snapshot.

Nevertheless, a reason for considering the change from having both R-Bits and Z-Bits to just having a C-Bit is that it may be likely that snapshots are formed using either RAID-5 or RAID-6 to conserve capacity. With an efficient RAID-6 scheme, the copy grain may naturally be selected to be 512 KB, which is the granularity of the Z-Bit.

An alternative structure for the SBLM 140 will now be briefly discussed. This alternative structure is useful, for example (but without limitation), in schemes that use a RAID-1 stripe size of 2 MB and up to 128 storage devices 100 in the ISE 120.

One of the advantages of using a relatively small copy grain size, such as 128 KB, is to reduce the overhead of copying RAID-1 data under highly random load scenarios. Nevertheless, such a smaller grain size can generally increase overhead requirements in terms of numbers of bits required to support a 128 KB grain size. In terms of I/O requests for copying RAID-1 data, it can be seen that a copy grain of 512 KB versus 128 KB would not be as onerous as it would be for a stripe size of 128 KB when the stripe size is 2 MB (or even 1 MB). There would still be 2 I/O requests at the larger stripe size. Performance data suggests that IOPS is cut in less than half when quadrupling the transfer size from 128 KB to 512 KB.

Accordingly, if stripe size is adjusted to 2 MB, sets of data (reliable storage units, or RSUs identified by RSUDs) are preferably doubled in size from 8 MB to 16 MB. R-Bits are unnecessary because the copy grain is set to 512 KB (which also supports RAID-5 and RAID-6).

With an RSU size of 16 MB and retention of the same number of “Row Bits” in the RSUD (as proposed above), 128 drives at 4TB each can now be supported in terms of the RSUD. The TLM shrinks to 2 KB from 4 KB when it is mapping a maximum of 2 TB, and a flat BLM can now map 4 GB instead of 2 GB. The number of entries (nodes) in the SBLM is reduced from 201 to 167, however, because of the additional bit overhead for the larger copy grain size. A preferred organization for this alternative SBLM structure is set forth in Table 4:

TABLE 4

| | |
|---|---|
| 0x0000 | Skip List Head |
| 0x0004 | Even Long Link Entries (4, 6, 8, 10, 12, 14) |
| 0x0020 | Short Link Entries (16 . . . 167) |
| 0x0150 | Free List Head |
| 0x0151 | Allocated Entry Count |
| 0x0152 | Unused [8 Bytes] |
| 0x015A | Key Table Entries (1 . . . 167) - Base: 0x0158 |
| 0x02A8 | MGD Table Entries (1 . . . 167) - Base: 0x02A0 |
| 0x07E0 | Odd Long Link Entries (1, 3, 5, 7, 9, 11, 13, 15) - |
| | Base: 0x07DC |

This second SBLM structure is only about ⅔ efficient as a flat BLM structure (167/256=65.234%), but this second structure can map up to about 2.6 GB of capacity. Assuming 25% of capacity is mapped “flat”, then this leaves 192 MB of SBLM entries. With this, 250 TB of virtual space can be mapped using segmented mapping and 128 TB of virtual space using flat mapping. With a worst case assumption of all storage being RAID level 0 (with 2 MB stripe size), 378 TB of capacity can be mapped using 256 MB of partner memory and 256 MB of media capacity.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising steps of arranging a storage element into a virtual storage space, and using a skip list to map, as individual nodes, each of a plurality of non-overlapping ranges of virtual block addresses (VBAs) of the virtual storage space.

2. The method of claim 1, wherein the plurality of non-overlapping ranges of VBAs of the using step are virtual addresses within an array of data storage devices of the storage element.

3. The method of claim 2, wherein the array of data storage devices comprises an array of hard disc drives, and wherein the storage element further comprises a processor and a writeback cache memory.

4. The method of claim 1, further comprising indexing a top level map to provide a key value, and using the key value to access the skip list.

5. The method of claim 4, wherein multiple entries of the top level map index to the same skip list.

6. The method of claim 1, wherein the skip list of the using step is characterized as a segmented bottom level map (SBLM) with a skip list head, a table of even long link entries (ELLEs), a table of odd long link level entries (OLLEs), a table of short link entries (SLEs), and a free list head.

7. The method of claim 1, wherein the skip list of the using step is characterized as a segmented bottom level map (SBLM), and wherein the method further comprises a step of converting the SBLM to a flat bottom level map (BLM) comprising a direct lookup array, wherein the flat BLM has a same overall size in memory as the SBLM.

8. The method of claim 1, wherein the arranging step comprises forming the virtual storage space across a plurality of storage elements each comprising an array of hard disc drives, and generating at least one skip list for each of said storage elements to map non-adjacent ranges of the virtual storage space therein.

9. An apparatus comprising:
a storage element comprising an array of data storage devices arranged into a virtual storage space, and
a data structure stored in memory of the storage element characterized as a skip list which maps, as individual nodes, each of a plurality of non-overlapping ranges of virtual block addresses (VBAs) of the virtual storage space.

10. The apparatus of claim 9, wherein the array of data storage devices comprises an array of individual hard disc drives.

11. The apparatus of claim 10, wherein the storage element further comprises a processor and a writeback cache memory, wherein the processor searches the skip list to identify a segment of data striped across at least some of said individual hard disc drives.

12. The apparatus of claim 9, wherein the data structure further comprises a top level map (TLM) which, when indexed, provides a key value used to access the skip list.

13. The apparatus of claim 12, wherein multiple entries of the TLM index to the same skip list.

14. The apparatus of claim 9, wherein the skip list is characterized as a segmented bottom level map (SBLM) with a skip list head, a table of even long link entries (ELLEs), a table of odd long link level entries (OLLEs), a table of short link entries (SLEs), and a free list head.

15. The apparatus of claim 9, wherein the skip list is characterized as a segmented bottom level map (SBLM), and wherein the storage element further comprises a processor configured to convert the SBLM to a flat bottom level map (BLM) comprising a direct lookup array, wherein the flat BLM has a same overall size in memory as the SBLM.

16. The apparatus of claim 9, further comprising a plurality of storage elements across which the virtual storage space is formed, each of the plurality of storage elements comprising an array of hard disc drives, and wherein each of the plurality of storage elements stores in an associated memory at least one skip list to map non-adjacent ranges of the virtual storage space therein.

17. An apparatus comprising:
a storage element comprising a processor, a memory and an array of data storage devices arranged into a virtual storage space;
a first data structure in said memory characterized as a skip list of nodes, each node corresponding to a first set of non-overlapping range of virtual block addresses (VBAs) of the virtual storage space; and
a second data structure in said memory characterized as a data array which outputs a key value for the skip list in response to an input VBA value for the virtual storage space.

18. The apparatus of claim 17, wherein the skip list of the first data structure is characterized as a first skip list, and wherein the apparatus further comprises a third data structure in said memory characterized as a second skip list of nodes each corresponding to a second set of non-overlapping range of VBAs different from the first set.

19. The apparatus of claim 17, wherein the processor accesses the second data structure in response to a host command for a data I/O operation with the array of data storage devices.

20. The apparatus of claim 17, wherein the processor converts the skip list of the first data structure into a third data structure in said memory characterized as a data array which facilitates direct lookup from an output from the second data structure.
